(19) United States
(12) Patent Application Publication
(10) Pub. No.: US 2004/0172947 A1
(43) Pub. Date: Sep. 9, 2004

(54) Turbine equipment and combined cycle power generation equipment and turbine operating method

(76) Inventor: Masayuki Takahama, Takasago-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/488,396

(22) PCT Filed: Feb. 26, 2003
(86) PCT No.: PCT/JP03/02120

(30) Foreign Application Priority Data
Mar. 4, 2002 (JP) 2002-056768

(51) Int. Cl. F02C 6/18

(52) U.S. Cl. 60/772; 60/39.182

(57) ABSTRACT

Turbine equipment with a TCA cooler (12), comprising a gas turbine (4) having a compressor (1), a combustor (2), and a turbine (3), the TCA cooler (12) for cooling fluid partly extracted from compressed air from the compressor (1) by leading the fluid therein and performing a heat exchange and leading the cooled fluid to the turbine (3) side of the gas turbine (4), and a temperature control means (15) for controlling the fluid on the outlet side of the TCA cooler (12) to a dew-point temperature or higher, whereby the dew condensation of moisture and vapor on the outlet side of the TCA cooler (12) can be eliminated, and the overcooling of the fluid partly extracted from the compressed air can be eliminated.

### Technical Field

This invention relates to turbine equipment furnished with a gas turbine comprising a compressor, a combustor, and a turbine, and also equipped with cooling means for cooling part of air from the compressor and supplying it to the turbine. Also, the invention relates to combined cycle power generation equipment provided with the turbine equipment. Moreover, the invention relates to a method for operating the turbine equipment.

From the viewpoints of economy and effective use of energy resources, various measures for improving efficiency have been implemented in power generation facilities. One of the measures is the employment of combined cycle power generation equipment in which a gas turbine and a steam turbine are combined. In the combined cycle power generation equipment, a high-temperature exhaust gas from the gas turbine is fed to a waste heat recovery boiler. In the waste heat recovery boiler, steam is generated via a heating unit, and the thus-generated steam is fed to the steam turbine, where the generated steam performs work.

High-temperature components, such as structures of the gas turbine and the combustor, are provided with various cooling systems from the aspect of heat resistance. For example, a fluid, which is part of compressed air extracted from the compressor, is cooled in a heat exchanger, and the cooled fluid is used as a cooling medium for the structure such as a turbine rotor. In this case, a cooling medium used in the heat exchanger for cooling the extracted air has been low pressure feed water within the plant or cooling water for bearings.

In accordance with the elevation of the combustion temperature in recent years, the combustor has become cooled with steam. In relation to combined cycle power generation equipment as well, there is a plan to use a steam turbine in combination with a gas turbine in which a high-temperature component, such as a combustor, is cooled by steam, to thereby construct a highly efficient power generation plant. For example, steam from a waste heat recovery boiler (intermediate-pressure steam) is bypassed to a combustor, whereby cooling steam is guided to the combustor, with the amount of the cooling steam being adjusted based on the temperature, pressure, etc., to supply a desired amount of cooling steam to the combustor.

With conventional gas turbine equipment, the cooling capacity of the heat exchanger, which cools fluid extracted as part of compressed air, has been designed in consideration of the cooling of the turbine rotor, etc. during normal operation. Thus, there has been concern that the temperature of the fluid cooled by the heat exchanger becomes too low during no-load operation or the like. If the temperature of the fluid is too low, the possibility has occurred that moisture in the compressed air extracted forms dew, which dwells within piping, or a mist scatters toward the turbine rotor.

The present invention has been accomplished in view of the foregoing circumstances. The object of the present invention is to provide turbine equipment having cooling means free from overcooling of a fluid extracted as part of compressed air, combined cycle power generation equipment provided with the turbine equipment, and a turbine operating method.

### DISCLOSURE OF THE INVENTION

Turbine equipment of the present invention is furnished with a gas turbine comprising a compressor, a combustor and a turbine; cooling means for admitting a fluid, which is part of compressed air extracted from the compressor, and cooling the fluid by heat exchange, in order for the cooled fluid to be introduced into the turbine of the gas turbine; and temperature control means for controlling the fluid on an outlet side of the cooling means to a predetermined temperature or higher. Thus, moisture does not form dew on the outlet side of the cooling means. As a result, there can be constructed turbine equipment furnished with the cooling means free from overcooling of the fluid extracted as part of compressed air. Consequently, the situations are avoided that dew formed dwells within piping to cause rust, and that a mist scatters over the turbine and adheres thereto, thereby damaging components of the turbine due to thermal stress.

Also, turbine equipment of the present invention is furnished with a gas turbine comprising a compressor, a combustor and a turbine; steam cooling means for introducing cooling steam into the combustor to carry out cooling; cooling means for admitting a fluid, which is part of compressed air extracted from the compressor, and cooling the fluid by heat exchange, in order for the cooled fluid to be introduced into the turbine of the gas turbine; and temperature control means for controlling the fluid on an outlet side of the cooling means to a predetermined temperature or higher. Thus, moisture or steam does not form dew on the outlet side of the cooling means. As a result, there can be constructed turbine equipment furnished with the cooling means free from overcooling of the fluid extracted as part of compressed air, and combined cycle power generation equipment furnished with the turbine equipment. Consequently, the situations are avoided that dew formed dwells within piping to cause rust, and that a mist scatters over the turbine and adheres thereto, thereby damaging components of the turbine due to thermal stress.

In the turbine equipment according to claim 1 or claim 2, the temperature control means includes a bypass path for bypassing the fluid to be introduced into the cooling means to the outlet side of the cooling means, and flow control means for controlling the flow rate of the bypass path. Thus, simple control enables the temperature at the outlet of the cooling means to be controlled unerringly.

In the turbine equipment according to claim 3, temperature detection means is provided for detecting the temperature of the fluid on the outlet side of the cooling means, and the temperature control means has the function of controlling the flow rate of the bypass path by controlling the flow control means in accordance with the detection status of the temperature detection means. Thus, the temperature at the outlet of the cooling means can be controlled unerringly. In the turbine equipment according to claim 3, moreover, the temperature control means prestores the flow rate of the bypass path commensurate with the operation schedule of the gas turbine, and has the function of controlling the flow control means according to the operation schedule of the gas turbine. Thus, simple control enables the temperature at the outlet of the cooling means to be controlled unerringly.

In the turbine equipment according to claim 1 or 2, the temperature control means is a plurality of fans for cooling the fluid flowing through the cooling means by air cooling. Thus, the temperature at the outlet of the cooling means can be controlled unerringly by simple instruments.

In the turbine equipment according to claim 6, temperature detection means is provided for detecting the temperature of the fluid on the outlet side of the cooling means, and the temperature control means has the function of controlling the number of the fans operated in accordance with the detection status of the temperature detection means. Thus, the temperature at the outlet of the cooling means can be controlled reliably and unerringly. In the turbine equipment according to claim 6, moreover, the temperature control means prestores the number of the fans operated which is commensurate with the operation schedule of the gas turbine, and has the function of controlling the number of the fans operated in accordance with the operation schedule of the gas turbine. Thus, simple control enables the temperature at the outlet of the cooling means to be controlled unerringly.

In the turbine equipment according to any one of claims 1 to 8, the temperature control means has the function of controlling the temperature of the fluid on the outlet side to a temperature higher than the dew point according to the operation status of the gas turbine. Thus, dew formation can be eliminated reliably. In the turbine equipment according to claim 9, the operation status of the gas turbine is a moisture status of the fluid to be introduced into the cooling means. In the turbine equipment according to claim 9, the operation status of the gas turbine is the temperature of air to be supplied to the compressor. In the turbine equipment according to claim 9, the operation status of the gas turbine is a load on the gas turbine. Thus, temperature control on the outlet side can be exercised unerringly.

Combined cycle power generation equipment of the present invention comprises the turbine equipment according to any one of claims 1 to 12, a waste heat recovery boiler for recovering waste heat of the gas turbine of the turbine equipment and generating steam; a steam turbine using steam generated by the waste heat recovery boiler as a power source; and condensing means for condensing exhaust steam of the steam turbine and supplying condensate water to the waste heat recovery boiler. Thus, there can be constructed power generation equipment furnished with turbine equipment free from dew formation of moisture on the outlet side of the cooling means. As a result, it is possible to provide combined cycle power generation equipment furnished with turbine equipment having cooling means free from overcooling of the fluid extracted as part of compressed air. Consequently, the situations are avoided that dew formed dwells within piping to cause rust, and that a mist scatters over the turbine and adheres thereto, thereby damaging components of the turbine due to thermal stress.

Moreover, combined cycle power generation equipment of the present invention comprises the turbine equipment according to any one of claims 1 to 12, a waste heat recovery boiler for recovering waste heat of the gas turbine of the turbine equipment and generating steam; steam cooling means for introducing part of steam generated by the waste heat recovery boiler into the combustor to perform cooling; a steam turbine using steam generated by the waste heat recovery boiler as a power source; and condensing means for condensing exhaust steam of the steam turbine and supplying condensate water to the waste heat recovery boiler. Thus, there can be constructed power generation equipment furnished with turbine equipment free from dew formation of moisture or steam on the outlet side of the cooling means. As a result, it is possible to provide combined cycle power generation equipment furnished with turbine equipment having cooling means free from overcooling of the fluid extracted as part of compressed air. Consequently, the situations are avoided that dew formed dwells within piping to cause rust, and that a mist scatters over the turbine and adheres thereto, thereby damaging components of the turbine due to thermal stress.

A turbine operating method of the present invention comprises cooling part of compressed air from a compressor such that the temperature thereof after cooling is a predetermined temperature higher than the dew point, or is a higher temperature than the predetermined temperature; and introducing a cooling fluid controlled to the predetermined temperature or higher temperature into a turbine. Thus, moisture after cooling does not form dew. As a result, it is possible to provide a turbine operating method free from overcooling of the fluid extracted as part of compressed air. Consequently, the situations are avoided that dew formed dwells within piping to cause rust, and that a mist scatters over the turbine and adheres thereto, thereby damaging components of the turbine due to thermal stress.

### BRIEF DESCRIPTION OF THE DRAWINGS

FIG. 1 is a schematic system diagram of combined cycle power generation equipment furnished with turbine equipment according to a first embodiment of the present invention.

FIG. 2 is a graph showing changes with time of a load on the turbine equipment.

FIG. 3 is a graph showing changes with time of the amount of cooling water.

FIG. 4 is a graph showing changes with time of the outlet temperature of cooling means.

FIG. 5 is a schematic system diagram of combined cycle power generation equipment furnished with turbine equipment according to a second embodiment of the present invention.

FIG.6 is a graph showing changes with time of the status of cooling fans.

FIG. 7 is a schematic system diagram of combined cycle power generation equipment furnished with turbine equipment according to a third embodiment of the present invention.

FIG. 8 is a schematic system diagram of combined cycle power generation equipment furnished with turbine equipment according to a fourth embodiment of the present invention.

FIG. 9 is a tabular view illustrating an example of the dew point temperature.

FIG. 10 is a tabular view illustrating another example of the dew point temperature.

FIG. 11 is a schematic system diagram of combined cycle power generation equipment furnished with turbine equipment according to a fifth embodiment of the present invention.

FIG. 12 is a graph showing the relationship between the number of the cooling fans operated and the outlet temperature of the cooling means versus the load.

FIG. 13 is a schematic system diagram of combined cycle power generation equipment furnished with turbine equipment according to a sixth embodiment of the present invention.

FIG. 14 is a graph showing the relationship between the bypass flow rate and the outlet temperature of the cooling means versus the load.

### BEST MODE FOR CARRYING OUT THE INVENTION

The present invention will be described in greater detail with reference to the accompanying drawings.

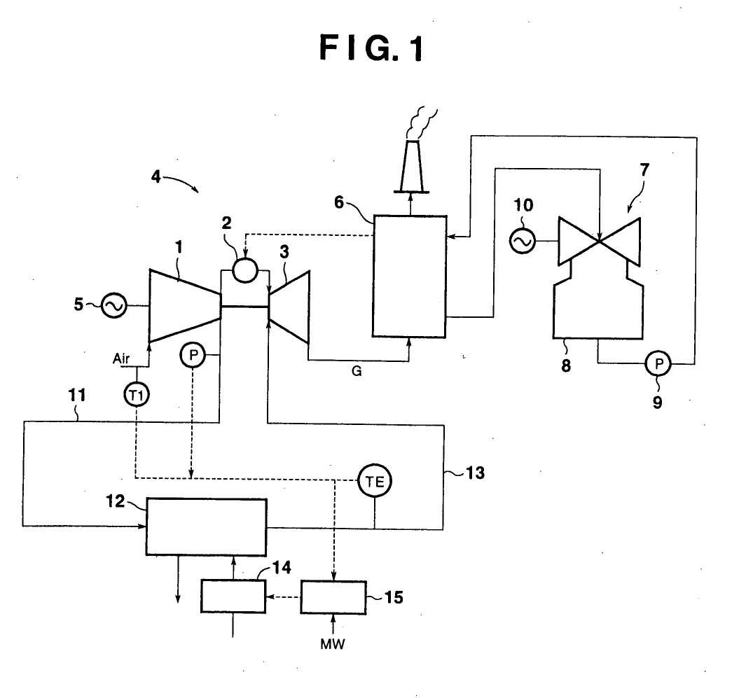

A first embodiment of the present invention is described based on FIGS. 1 to 4.

As shown in FIG. 1, a gas turbine 4 having a compressor 1, a combustor 2 and a turbine 3 is provided, and a generator 5 is provided coaxially in the gas turbine 4. Exhaust gas G from the gas turbine 4 is fed to a waste heat recovery boiler 6. In the waste heat recovery boiler 6, steam is produced by the exhaust gas G via a heating unit (not shown).

Steam produced in the waste heat recovery boiler 6 is fed to a steam turbine 7, where it does work. Steam discharged from the steam turbine 7 is condensed by a condenser 8, and condensate water is supplied to the waste heat recovery boiler 6 by a water feed pump 9 (condensing means). Of the numerals in the drawing, 10 denotes a generator connected to the steam turbine 7.

On the other hand, a fluid, which is part of compressed air extracted from compressed air in the compressor 1 of the gas turbine 4, is introduced into a TCA cooler 12, as cooling means, through an extraction path 11. The fluid, extracted as part of compressed air, is cooled in the TCA cooler 12, and the cooled fluid is introduced through a cooling path 13 into the turbine 3 for cooling of blade and rotor, etc. of the turbine 3. The TCA cooler 12 is supplied with cooling water present within the system (for example, cooling water for bearings) for use as a cooling medium. The combustor 2 is supplied with cooling steam from the waste heat recovery boiler 6.

The amount of cooling water to be supplied to the TCA cooler 12 can be adjusted by flow control means 14, and the flow rate in the flow control means 14 is controlled by control means 15, so that the temperature of the cooled fluid on the outlet side of the TCA cooler 12 is controlled to a predetermined temperature or higher (temperature control means).

Inlet air temperature T1 of the compressor 1, outlet pressure P of the compressor 1, fluid temperature TE of the cooling path 13 (temperature detection means), and load MW on the gas turbine 4 are entered into the control means 15. Based on these pieces of information (operation status of the gas turbine 4), the fluid temperature TE of the cooling path 13 is controlled to a temperature higher than the dew point. Cooling steam supplied to the combustor 2 leaks, and partly mixes into cooling air (air extracted from the compressor 1). With its amount of mixing (moisture status of the fluid) being taken into account, the fluid temperature TE of the cooling path 13 is controlled to the temperature higher than the dew point.

As noted above, the fluid temperature TE of the cooling path 13 is controlled to the temperature higher than the dew point. However, it is possible, for example, to set, as a threshold value, a temperature at which dew formation does not occur regardless of the moisture content status or the load status, and to control the flow control means 14 such that the fluid temperature TE of the cooling path 13 does not fall short of the threshold value.

As described above, the turbine equipment controls the fluid temperature TE of the cooling path 13 on the outlet side of the TCA cooler 12 to the temperature higher than the dew point. Thus, moisture or steam contained in the fluid does not form dew within the piping of the cooling path 13. If steam for cooling the combustor 2 leaks and mixes into cooling air, in particular, the dew point temperature for dew formation in the cooler 13 rises, facilitating dew formation. In this case, the fluid temperature TE of the cooling path 13 is controlled to an even higher temperature in expectation of this phenomenon, whereby dew formation of moisture can be reliably eliminated.

Hence, there can be provided turbine equipment having the TCA cooler 12 free from overcooling of the fluid extracted as part of compressed air, and combined cycle power generation equipment furnished with this turbine equipment. Consequently, the possibility that dew formed dwells within the piping to cause rust is no more existent. Nor is there any possibility that a mist scatters over the turbine 3 and adheres thereto, thereby damaging the components of the turbine 3 due to thermal stress.

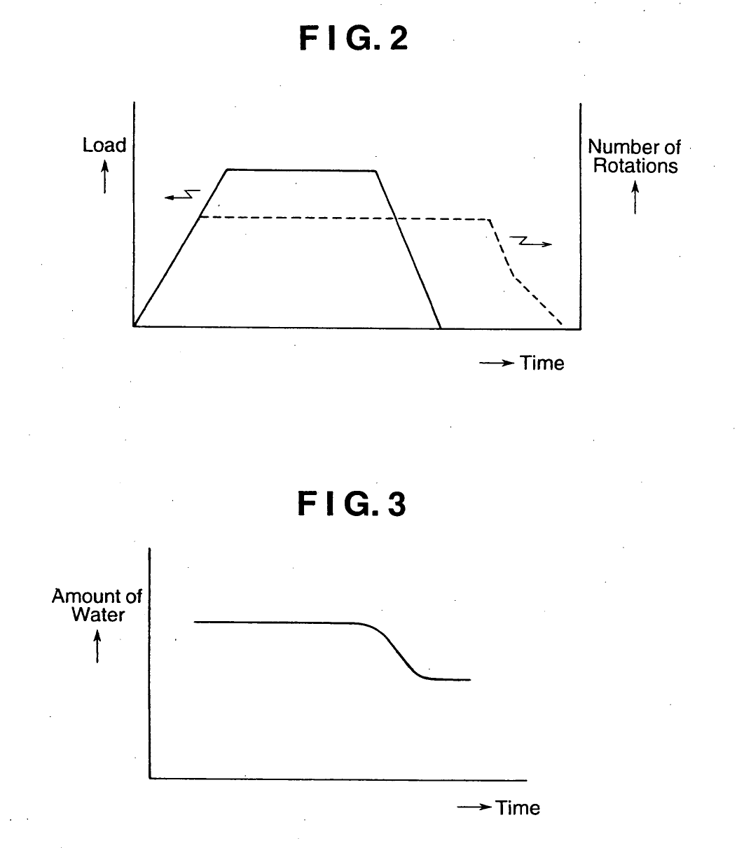

Control of the fluid temperature in the cooling path 13 will be concretely explained based on FIGS. 2 to 4.

As shown in FIG. 2, the load on the gas turbine 4 increases from the start of operation, and operation continues under a predetermined load during rated operation. As shown in FIG. 3, during this period, the amount of cooling water supplied to the TCA cooler 12 is set in agreement with the load during rated operation, and cooling water is supplied at the set flow rate to cool the fluid fed to the cooling path 13. When the load on the gas turbine 4 is reduced, for example, by stoppage of operation as shown in FIG. 2 (as shown by a dotted line in the drawing, the rotational speed decreases after the load decreases, i.e. with a time delay), the amount of cooling water supplied to the TCA cooler 12 is decreased.

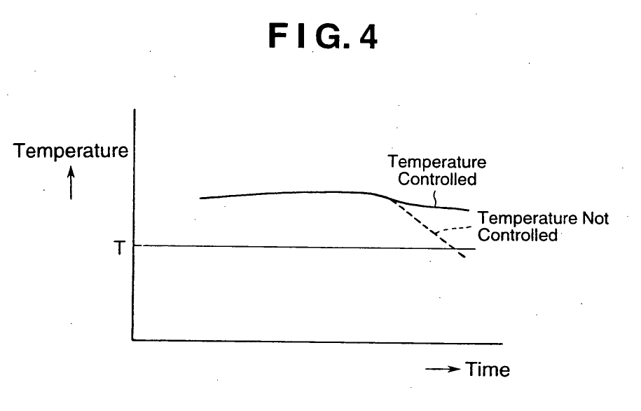

By adjusting the amount of cooling water supplied to the TCA cooler 12 in response to the load on the gas turbine 4, the temperature of the fluid fed to the cooling path 13 does not fall short of dew point T, as shown by a solid line in FIG. 4. If the amount of cooling water is not decreased after the load on the gas turbine 4 declines, the temperature of the fluid fed to the cooling path 13 falls short of the dew point T, as shown by a dotted line in FIG. 4.

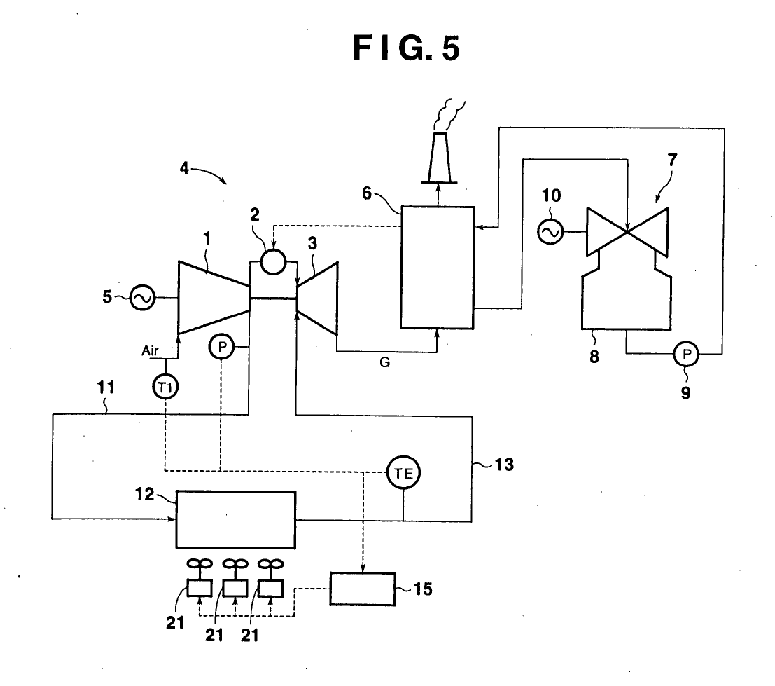

In the above-described first embodiment, control of the temperature of the fluid fed to the cooling path 13 is exercised by adjusting the amount of cooling water while using the cooling medium of the TCA cooler 12 as the cooling water. However, as shown in FIG. 5, control of the temperature of the fluid fed to the cooling path 13 can be exercised by air cooling using a plurality of fans.

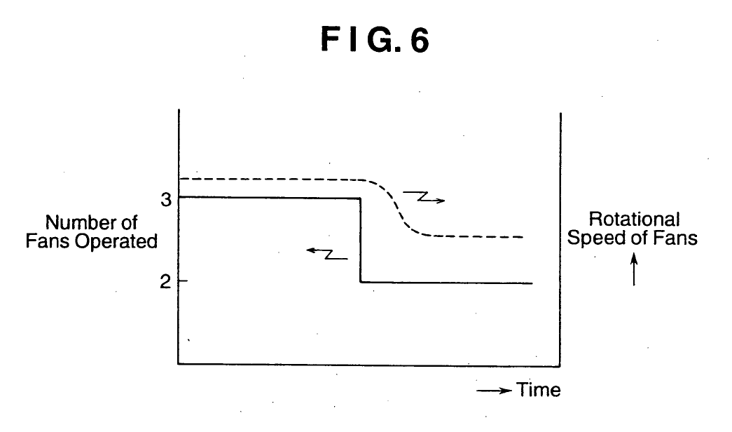

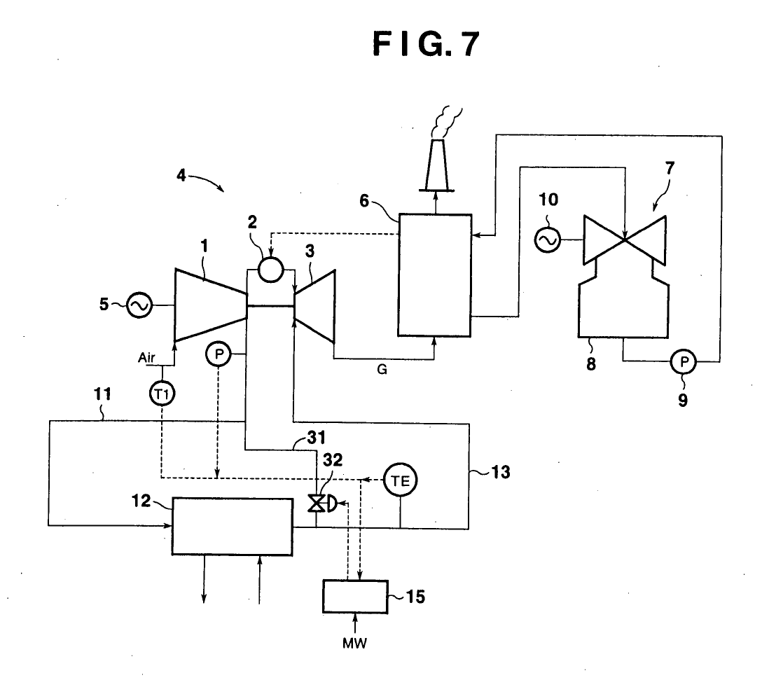

That is, as shown in FIG. 5, the TCA cooler 12 is constituted such that the fluid, as part of compressed air extracted, is cooled by three cooling fans 21. In this case, instead of control for decreasing the amount of cooling water after a drop in the load on the gas turbine 4, control of the temperature of the fluid fed to the cooling path 13 can be exercised by decreasing the number of the cooling fans 21 operated from three to two as shown by a solid line in FIG. 6, or by lowering the rotational speed of the fans as shown by a dotted line in FIG. 7.

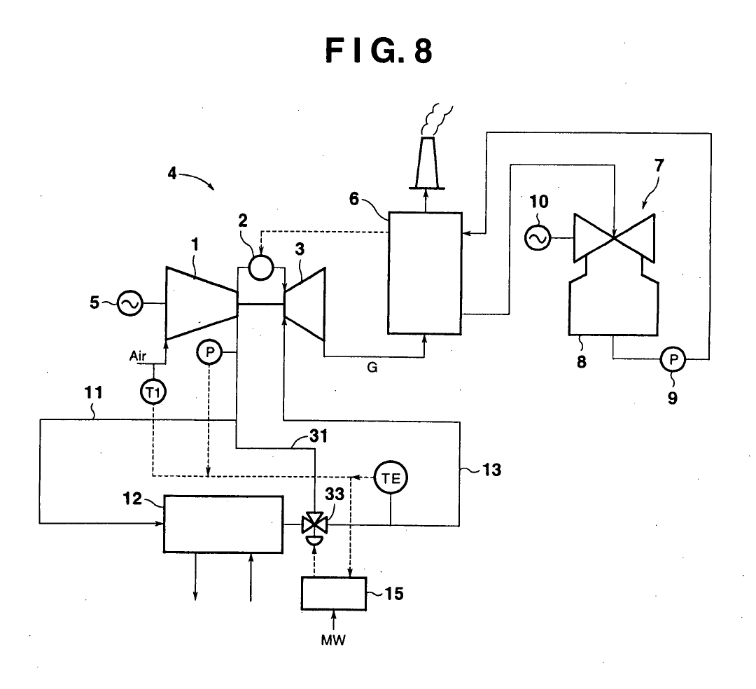

Other examples of the temperature control means for cooling air will be explained based on FIGS. 7 and 8. The same members as the members shown in FIG. 1 will be assigned the same numerals and symbols as in FIG. 1, and duplicate explanations are omitted.

As shown in FIG. 7 (third embodiment), a bypass path 31 is provided as a branch from the extraction path 11, and the bypass path 31 is connected to the outlet side of the TCA cooler 12 (cooling path 13). An on-off valve 32, as flow control means, is provided in the bypass path 31, and the on-off valve 32 is controlled so as to be open or closed by the command of the control means 15. The flow control means 14 shown in FIG. 1 is not provided, and the TCA cooler 12 is configured to cool, in a constant state (with cooling water or the like supplied in a constant amount), the fluid (air) from the extraction path 11. Thus, by controlling the on-off valve 32, high-temperature air from the bypass path 31 is mixed with low-temperature air at the outlet of the TCA cooler 12, whereby the fluid temperature TE of the cooling path 13 is controlled to the desired temperature. Because of this configuration, simple control enables the temperature at the outlet of the TCA cooler 12 to be controlled unerringly.

The temperature control means shown in FIG. 8 (fourth embodiment) is configured to have, instead of the on-off valve 32, a three-way valve 33 as flow control means at the junction (confluence) between the bypass path 31 and the cooling path 13. The three-way valve 33 is controlled by the command of the control means 15. As a result, high-temperature air from the bypass path 31 and low-temperature air at the outlet of the TCA cooler 12 are mixed in suitable proportions, whereby the fluid temperature TE of the cooling path 13 is controlled to the desired temperature. Because of this configuration, simple control enables the temperature at the outlet of the TCA cooler 12 to be controlled unerringly.

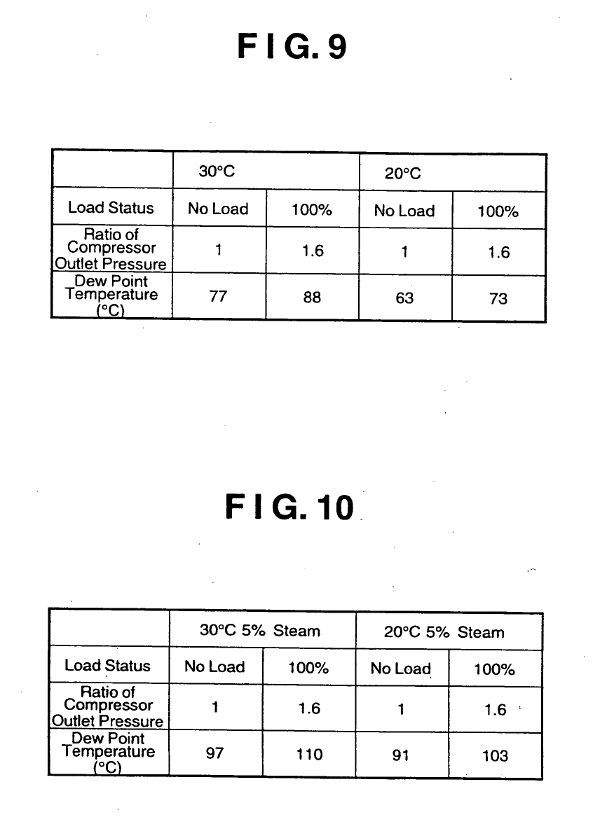

With reference to FIGS. 9 and 10, an example of the dew point temperature based on the operation status will be described in the absence or presence of steam leakage. FIG. 9 shows a case where the inlet temperature of the compressor 1 is 30° C. or 20° C. in the absence of steam leakage. FIG. 10 shows a case where the inlet temperature of the compressor 1 is 30° C or 20° C. in the presence of steam leakage of 5%. The load status at each temperature is no-load or 100%, and the ratio of the outlet pressures of the compressor 1 under no-load and 100% load conditions are 1:1.6.

As shown in FIG. 9, if there is no leakage of steam for cooling of the combustor, the dew point temperature is 77° C. under no load and 88° C. under a load of 100% when the inlet temperature of the compressor 1 is 30° C., while the dew point temperature is 63° C. under no load and 73° C. under a load of 100% when the inlet temperature of the compressor 1 is 20° C. Thus, the higher the inlet temperature of the compressor 1 and the higher the load, the higher the dew point temperature is. In accordance with this status, control over the amount of cooling water is exercised so as to decrease the amount of cooling water as the inlet temperature of the compressor 1 becomes high and the load becomes high. In this manner, control of the dew point temperature can be exercised unerringly.

As shown in FIG. 10, if the leakage of steam for cooling of the combustor is set at 5% (normally, leakage of steam for combustor cooling is 1% or less), the dew point temperature is 97° C. under no-load conditions and 110° C. under a load of 100% when the inlet temperature of the compressor 1 is 30° C., while the dew point temperature is 91° C. under no load, and 103° C. under a load of 100%, when the inlet temperature of the compressor 1 is 20° C. Thus, the higher the inlet temperature of the compressor 1 and the higher the load, the higher the dew point temperature is. If steam is contained, the dew point temperature is absolutely further higher. In accordance with this status, control over the amount of cooling water is exercised so as to decrease the amount of cooling water as the inlet temperature of the compressor 1 increases and the load increases. In this manner, control of the dew point temperature can be exercised unerringly.

The foregoing embodiments have been described, for example, with reference to the turbine equipment in which cooling steam is supplied to the combustor 2, and this steam may be incorporated into extracted air. However, the present invention is applicable to turbine equipment in which cooling steam is not supplied and the steam is not incorporated into extracted air, and it is also possible to eliminate dew formation by deriving the dew point temperature in response to humidity or the like.

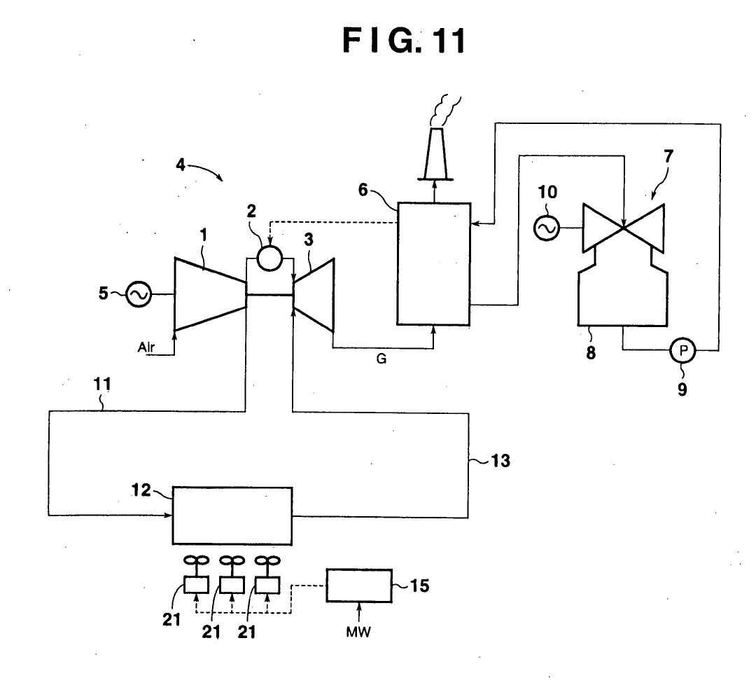

The fifth embodiment will be described based on FIG. 11. The same members as in the configuration of the second embodiment shown in FIG. 5 will be assigned the same numerals and symbols as in FIG. 5, and duplicate explanations will be omitted.

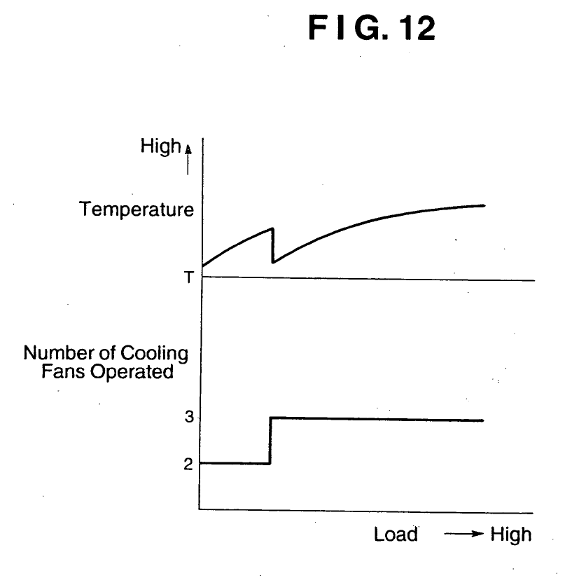

In the equipment shown in FIG. 11, the number of the cooling fans 21 in operation according to the operation schedule of the gas turbine 4 is prestored in the control means 15. That is, as shown in FIG. 12, the number of the cooling fans 21 operated is set with respect to the load commensurate with the operation schedule such that the number of the cooling fans 21 operated is set at two under a low load, whereas the number of the cooling fans 21 operated is set at three at a time when the load is somewhat high.

A load MW on the gas turbine 4 is inputted into the control means 15, and a predetermined number of the cooling fans 21 are operated in response to changes in the load (operation schedule).

Thus, when the load is low, the fluid (air) from the extraction path 11 is cooled by two of the cooling fans 21 to control the fluid temperature of the cooling path 13 to the desired temperature. When the fluid temperature of the cooling path 13 rises, the number of the cooling fans 21 in operation is changed to three. The fluid (air) from the extraction path 11 is cooled by the three cooling fans 21, so that the fluid temperature of the cooling path 13 is controlled to the desired temperature. Thus, simple control enables the temperature at the outlet of the TCA cooler 12 to be controlled unerringly, without the use of temperature control based on temperature detection by a thermocouple or the like.

Hence, there can be provided turbine equipment having the TCA cooler 12 free from overcooling of the fluid extracted as part of compressed air, and combined cycle power generation equipment furnished with this turbine equipment. Consequently, the possibility that dew formed dwells within the piping to cause rust is no more existent. Nor is there any possibility that a mist scatters over the turbine 3 and adheres thereto, thereby damaging the components of the turbine 3 due to thermal stress.

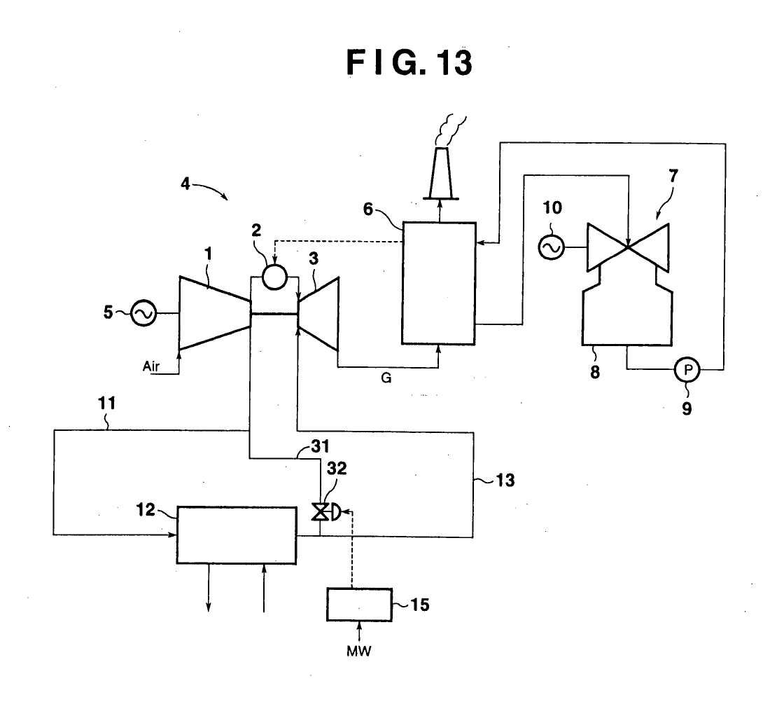

The fifth embodiment will be described based on FIG. 13. The same members as in the configuration of the third embodiment shown in FIG. 7 will be assigned the same numerals and symbols as in FIG. 7, and duplicate explanations will be omitted.

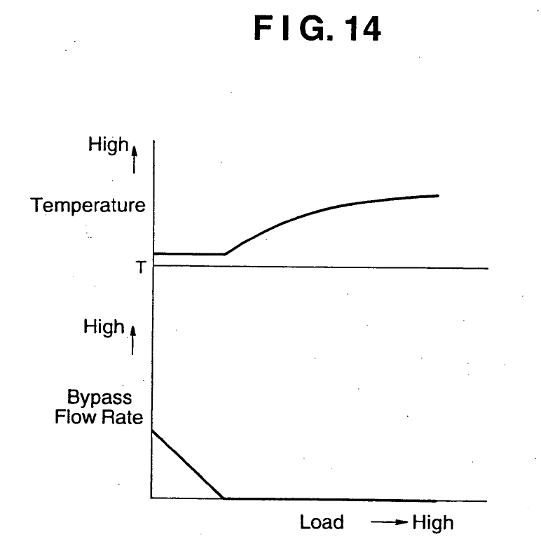

In the equipment shown in FIG. 13, the flow rate of the bypass path 32 according to the operation schedule of the gas turbine 4 is prestored in the control means 15. That is, as shown in FIG. 14, the flow rate of the bypass path 32 is set with respect to the load commensurate with the operation schedule such that the flow rate of the bypass path 32 is set to be high under a low load, whereas the flow rate of the bypass path 32 is set to be gradually decreased as the load is increased.

A load MW on the gas turbine 4 is inputted into the control means 15, and a control valve 32 is controlled such that the flow rate of the bypass path 32 becomes a predetermined flow rate in response to changes in the load (operation schedule).

Thus, when the load is low, the high-temperature fluid (air) from the extraction path 11 is mixed in a large amount at the outlet of the TCA cooler 12, whereby the fluid temperature of the cooling path 13 is controlled to the desired temperature. When the load increases to raise the fluid temperature of the cooling path 13, the total amount of the high-temperature fluid (air) from the extraction path 11 is fed to the TCA cooler 12, so that the fluid temperature of the cooling path 13 is controlled to the desired temperature. Thus, simple control enables the temperature at the outlet of the TCA cooler 12 to be controlled unerringly, without the use of temperature control based on temperature detection by a thermocouple or the like.

Hence, there can be provided turbine equipment having the TCA cooler 12 free from overcooling of the fluid extracted as part of compressed air, and combined cycle power generation equipment furnished with this turbine equipment. Consequently, the possibility that dew formed dwells within the piping to cause rust is no more existent. Nor is there any possibility that a mist scatters over the turbine 3 and adheres thereto, thereby damaging the components of the turbine 3 due to thermal stress.

### Industrial Applicability

As described above, there is provided turbine equipment in which part of compressed air is cooled, and introduced into the gas turbine, with its temperature after cooling being rendered higher than the dew point. Thus, the turbine equipment is free from overcooling of the fluid extracted as part of compressed air. Consequently, the possibility that dew formed dwells within the piping on the outlet side of the TCA cooler to cause rust is no more existent. Nor is there any possibility that a mist scatters over the turbine and adheres thereto, thereby damaging the components of the turbine due to thermal stress.

1. Turbine equipment comprising:
a gas turbine comprising a compressor, a combustor and a turbine;
cooling means for admitting a fluid, which is part of compressed air extracted from said compressor, and cooling the fluid by heat exchange, in order for the cooled fluid to be introduced into said turbine of said gas turbine; and
temperature control means for controlling the fluid on an outlet side of said cooling means to a predetermined temperature or higher.

2. Turbine equipment comprising:
a gas turbine comprising a compressor, a combustor and a turbine;
steam cooling means for introducing cooling steam into said combustor to carry out cooling;
cooling means for admitting a fluid, which is part of compressed air extracted from said compressor, and cooling the fluid by heat exchange, in order for the cooled fluid to be introduced into said turbine of said gas turbine; and
temperature control means for controlling the fluid on an outlet side of said cooling means to a predetermined temperature or higher.

3. The turbine equipment according to claim 1 or claim 2, characterized in that said temperature control means includes a bypass path for bypassing the fluid to be introduced into said cooling means to the outlet side of said cooling means, and flow control means for controlling a flow rate of said bypass path.

4. The turbine equipment according to claim 3, characterized in that temperature detection means is provided for detecting the temperature of the fluid on the outlet side of said cooling means, and said temperature control means has a function of controlling the flow rate of said bypass path by controlling said flow control means in accordance with a detection status of said temperature detection means.

5. The turbine equipment according to claim 3, characterized in that said temperature control means prestores the flow rate of said bypass path commensurate with an operation schedule of said gas turbine and has a function of controlling said flow control means according to the operation schedule of said gas turbine.

6. The turbine equipment according to claim 1 or 2, characterized in that said temperature control means is a plurality of fans for cooling the fluid flowing through said cooling means by air cooling.

7. The turbine equipment according to claim 6, characterized in that temperature detection means is provided for detecting the temperature of the fluid on the outlet side of said cooling means, and said temperature control means has a function of controlling the number of said fans operated in accordance with a detection status of said temperature detection means.

8. The turbine equipment according to claim 6, characterized in that said temperature control means prestores the number of said fans operated which is commensurate with an operation schedule of said gas turbine, and has a function of controlling the number of said fans operated in accordance with the operation schedule of said gas turbine.

9. The turbine equipment according to any one of claims 1 to 8, characterized in that said temperature control means has a function of controlling the temperature of the fluid on the outlet side to a temperature higher than a dew point according to an operation status of said gas turbine.

10. The turbine equipment according to claim 9, characterized in that the operation status of said gas turbine is a moisture status of the fluid to be introduced into said cooling means.

11. The turbine equipment according to claim 9, characterized in that the operation status of said gas turbine is a temperature of air to be supplied to said compressor.

12. The turbine equipment according to claim 9, characterized in that the operation status of said gas turbine is a load on said gas turbine.

13. Combined cycle power generation equipment comprising:
the turbine equipment according to any one of claims 1 to 12;
a waste heat recovery boiler for recovering waste heat of the gas turbine of said turbine equipment and generating steam;
a steam turbine using steam generated by said waste heat recovery boiler as a power source; and
condensing means for condensing exhaust steam of said steam turbine and supplying condensate water to said waste heat recovery boiler.

14. Combined cycle power generation equipment comprising:
the turbine equipment according to any one of claims 1 to 12;
a waste heat recovery boiler for recovering waste heat of the gas turbine of said turbine equipment and generating steam;
steam cooling means for introducing part of steam generated by said waste heat recovery boiler into the combustor to perform cooling;
a steam turbine using steam generated by said waste heat recovery boiler as a power source; and
condensing means for condensing exhaust steam of said steam turbine and supplying condensate water to said waste heat recovery boiler.

15. A turbine operating method characterized by:
cooling part of compressed air from a compressor such that a temperature thereof after cooling is a predetermined temperature higher than a dew point, or is a higher temperature than the predetermined temperature; and
introducing a cooling fluid controlled to the predetermined temperature or higher temperature into a turbine.
